(19) United States
(12) Patent Application Publication
(10) Pub. No.: US 2017/0217518 A1
(43) Pub. Date: Aug. 3, 2017

(54) CRAWLER ASSEMBLY FOR A CATWALK

(71) Applicant: FORUM US, INC., HOUSTON, TX (US)

(72) Inventors: Carlos Daniel Vadillo Benavides, Houston, TX (US); Ryan Douglas WERNER, Lacombe (CA); Michael Jason POULSEN, Sylvan Lake (CA)

(21) Appl. No.: 15/009,274

(22) Filed: Jan. 28, 2016

(51) Int. Cl. B62D 57/02

(52) U.S. Cl. CPC B62D 57/02

(57) ABSTRACT

Embodiments disclosed herein generally relate to a catwalk and, more specifically, to a crawler assembly for a catwalk. The catwalk includes a frame and a crawler having a plurality of leg assemblies coupled to the frame. The frame defines an interior volume of the catwalk. Each leg assembly includes a vertical leg component, a foot component, and a horizontal leg component. The foot component is coupled to the vertical leg component. The vertical leg component is configured to actuate the foot component in a vertical direction. The horizontal leg component is coupled to the vertical leg component. The horizontal leg component is configured to actuate the foot component between a stowed position substantially within the interior volume and an extended position substantially outside the interior volume.

### BACKGROUND

### Field

Embodiments of the disclosure relate to a catwalk and, more specifically, to a crawler assembly for a catwalk.

### Description of the Related Art

Pipe launchers are used for presenting and receiving sections of pipe to and from drilling rig platforms. The pipe launchers are often referred to as “catwalks” as they include platforms that run along their length for service personnel to walk upon. The catwalks are typically heavy and difficult to move. In the oil industry, it is sometimes necessary to drill multiple holes in the ground and to move the drilling rigs. Therefore, the catwalks may need to be moved to multiple locations for presenting and receiving sections of pipe to and from the drilling rig platform.

Thus, there is a continuing need for improved catwalk transport designs.

### SUMMARY

Embodiments disclosed herein generally relate to a catwalk and, more specifically, to a crawler assembly for a catwalk. In one embodiment, a catwalk is disclosed herein. The catwalk includes a frame and a crawler having a plurality of leg assemblies coupled to the frame. The frame defines an interior volume of the catwalk. Each leg assembly includes a vertical leg component, a foot component, and a horizontal leg component. The foot component is coupled to the vertical leg component. The vertical leg component is configured to actuate the foot component in a vertical direction. The horizontal leg component is coupled to the vertical leg component. The horizontal leg component is configured to actuate the foot component between a stowed position substantially within the interior volume and an extended position substantially outside the interior volume.

In another embodiment, a method for moving a catwalk having a plurality of leg assemblies is disclosed herein. The method includes extending a horizontal leg component such that a foot component is moved from a stowed position within an interior volume of the catwalk to an extended position outside the interior volume and extending a vertical leg component such that the foot component contacts a ground and that the catwalk is raised from the ground.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic front view of a catwalk, according to one embodiment.

FIG. 2 is a perspective front view of the catwalk, according to one embodiment.

FIG. 3A is a perspective view of a leg assembly in a locked position, according to one embodiment.

FIG. 3B is a perspective view of the leg assembly of FIG. 3A in an open position, according to one embodiment.

FIG. 4A is a perspective view of a catwalk with leg assemblies in a stowed position, according to one embodiment.

FIG. 4B is a perspective view of the catwalk of FIG. 4A with leg assemblies in an extended position, according to one embodiment.

FIG. 4C is a perspective view of the catwalk of FIG. 4B with leg assemblies actuated in a vertical direction, according to one embodiment.

For clarity, identical reference numerals have been used, where applicable, to designate identical elements that are common between figures. Additionally, elements of one embodiment may be advantageously adapted for utilization in other embodiments described herein.

### DETAILED DESCRIPTION

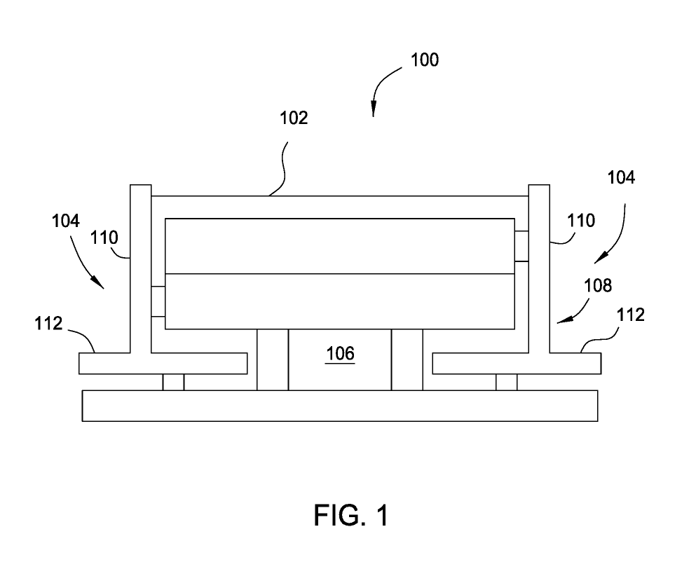

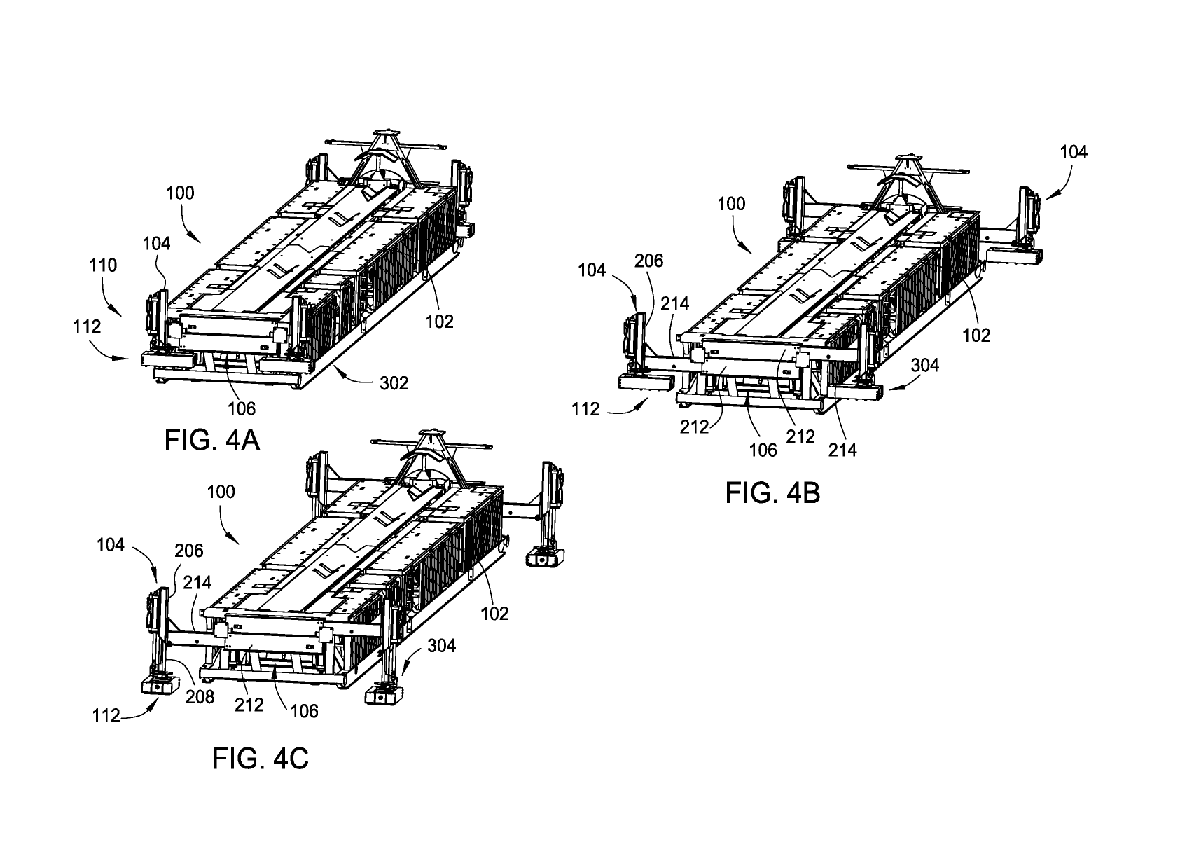

FIG. 1 is a schematic front view of a catwalk 100, according to one embodiment. The catwalk 100 includes a frame 102 defining an interior volume 106 and a crawler 104 having a plurality of leg assemblies 110 coupled to the frame 102. The leg assemblies 110 are configured to be moved between a stowed position 108 as shown in FIG. 1, and an extended position as shown in FIGS. 4B and 4C. Each leg assembly 110 has a foot component 112 coupled to the leg assembly 110. In the stowed position 108, the leg assembly 110 actuates the foot component 112 partially within the interior volume 106 of the catwalk 100. In one embodiment, the foot component 112 is positioned entirely within the interior volume 106. In another embodiment, the foot component 112 is at least partially positioned within the interior volume 106 of the catwalk 100. In the extended position, the leg assembly 110 actuates the foot component 112 to a position entirely outside the interior volume 106. When in the extended position, the leg assemblies 110 are configured to move the catwalk 100.

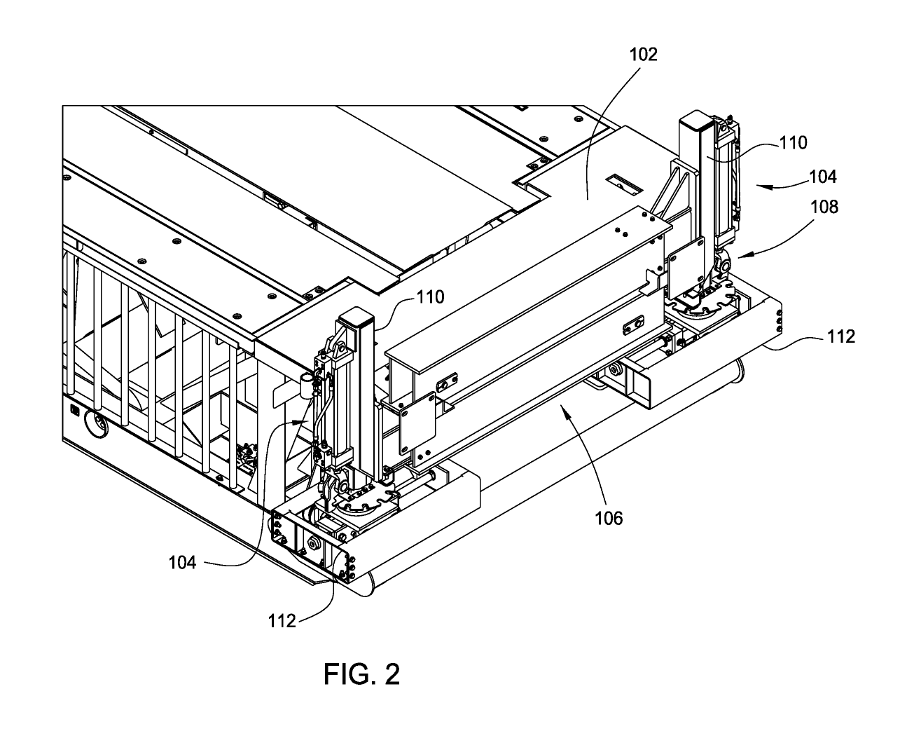

FIG. 2 illustrates a perspective view of the catwalk 100, according to one embodiment. As illustrated, the leg assemblies 110 are configured to be moved within the interior volume 106 of the catwalk 100. Traditional crawler assemblies positioned on the outside of the catwalk frame need to be removed when the catwalk is being transported because the overall width of the catwalk with the crawler assembly is too wide to safely transport. Removing and attaching the crawler assembly to the catwalk each time the catwalk has to be transported makes rig up and rig down time consuming. With the crawler 104 of the catwalk 100 as described herein, there is no longer a need to remove the crawler 104 because the leg assemblies 110 can be stowed within the interior volume 106 of the catwalk 100, thereby reducing the overall width of the catwalk 100 with the crawler 104 attached. Thus, the crawler 104 makes rig up and rig down time for the catwalk 100 much quicker compared to traditional crawler assemblies.

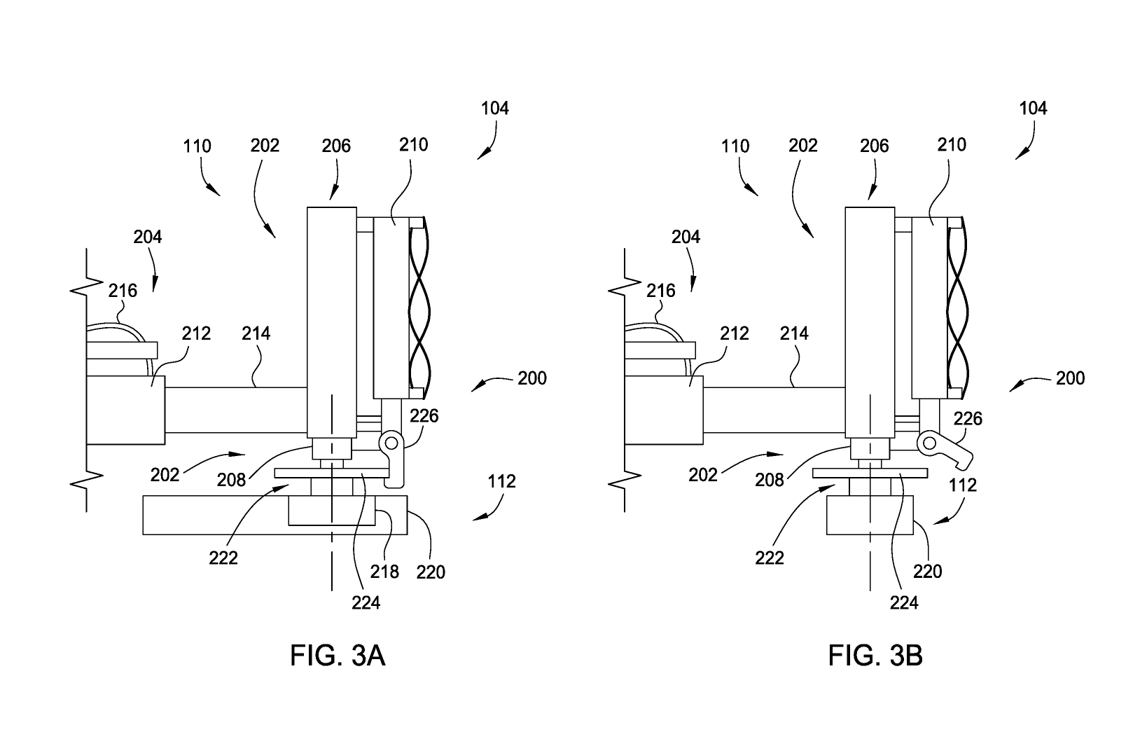

FIGS. 3A and 3B illustrate perspective views of a leg assembly 110 of the crawler 104 with the foot component 112 in a locked position 200 and unlocked position 201, respectively, according to one embodiment. The foot component 112 is rotatably coupled to the leg assembly 110. The leg assembly 110 includes a vertical leg component 202 and a horizontal leg component 204.

The horizontal leg component 204 is formed from a horizontal fixed leg member 212 and a horizontal movable leg member 214 slidably coupled to the horizontal fixed leg member 212. The horizontal movable leg member 214 may be disposed within the horizontal fixed leg member 212 whereby the horizontal movable leg member 214 is configured to move in and out, or telescope, with respect to the horizontal fixed leg member 212 to extend or contract the length of the horizontal leg component 204. An actuator 216 may be coupled to the horizontal leg component 204 to control the movement of the horizontal movable leg member 214 with respect to the horizontal fixed leg member 212. The actuator 216 may be a pneumatic actuator, a hydraulic cylinder, or the like. The horizontal movable leg member 214 is coupled to the vertical leg component 202 and is configured to move the vertical leg component 202 relative to the catwalk 100 such that the foot component 112 may be moved between a stowed position and an extended position.

The vertical leg component 202 is formed from a vertical fixed leg member 206 and a vertical movable leg member 208 slidably coupled to the vertical fixed leg member 206. The vertical movable leg member 208 may be disposed within the vertical fixed leg member 206 whereby the vertical movable leg member 208 is configured to move in and out, or telescope, with respect to the vertical fixed leg member 206 to extend or contract the length of the vertical leg component 202. An actuator 210 may be coupled to the vertical leg component 202 to control the movement of the vertical movable leg member 208 with respect to the vertical fixed leg member 206. The actuator 210 may be a pneumatic actuator, a hydraulic cylinder, or the like. The foot component 112 is coupled to the vertical movable leg member 208. The vertical leg component 202 is configured to move the foot component 112 until the foot component 112 touches the ground such that the crawler 104 raises the catwalk 100 off of the ground.

The foot component 112 includes a foot 218 and a foot housing 220. The foot 218 is slidably coupled to the foot housing 220 such that the foot 218 is configured to move the vertical leg component 202 along the foot housing 220. The foot 218 may be coupled to the vertical leg component 202 by a coupler 222. The coupler 222 may include a wheel 224 and a lock component 226 to rotate the foot 218 relative to the vertical leg component 202. The wheel 224 is configured to turn the foot component 112 in a desired direction and includes a plurality of notches for engagement with the lock component 226 to lock the foot component 112 in place. For example, the foot component 112 may be positioned such that the crawler 104 walks the catwalk 100 forward and/or backwards, laterally to the side, and/or in an angled direction. The lock component 226 is configured to lock the foot component 112 in the desired direction. In the embodiment shown in FIG. 3A, the foot component 112 is shown in a locked position 200 with the lock component 226 engaging the wheel 224 and preventing the foot component 112 from rotating. In the embodiment shown in FIG. 3B, the foot component 112 is shown in an unlocked position 201, with the lock component 226 free from the wheel 224.

FIGS. 4A-4B illustrates the catwalk 100 being raised using the leg assemblies 110 of the crawler 104, according to one embodiment.

FIG. 4A illustrates the catwalk 100 resting on the ground. The crawler 104 of the catwalk 100 includes four leg assemblies 110, each positioned at a corner of the catwalk 100. Additional leg assemblies 110 may be added, if desired. The leg assemblies 110 are initially shown in a stowed position 302 within the interior volume 106 of the catwalk 100.

FIG. 4B illustrates the catwalk 100 resting on the ground with the leg assemblies 110 in an extended position 304. The horizontal leg component 204 extends the crawler 104 from the stowed position 302 to the extended position 304 outside the interior volume 106. To do so, the actuator 216 moves the horizontal movable leg member 214 relative to the horizontal fixed leg member 212, until the foot component 112 clears the frame 102 of the catwalk 100.

FIG. 4C illustrates the catwalk 100 raised from the ground by the leg assemblies 110. The leg assemblies 110 raise the catwalk 100 from the ground by extending the vertical leg component 202 such that the foot component 112 contacts the ground. The vertical leg component 202 continues to push the foot component 112 against the ground until catwalk 100 is raised a desired distance. To do so, the actuator 210 moves the vertical movable leg member 208 relative to the vertical fixed leg member 206. Once the catwalk 100 is in the desired raised position, the foot 218 of each crawler 104 is moved relative to the foot housing 220 to move the catwalk 100 forwards, backwards, laterally, or at an angle in the direction that the foot 218 is oriented. The process may be repeated as known in the art to move the catwalk 100 in the desired direction.

Other and further embodiments of the invention may be devised without departing from the basis scope thereof, and the scope thereof is determined by the claims that follow.

1. A catwalk, comprising:
a frame defining an interior volume of the catwalk; and
a crawler having a plurality of leg assemblies coupled to the frame, each leg assembly comprising:
a vertical leg component;
a foot component coupled to the vertical leg component, wherein the vertical leg component is configured to actuate the foot component in a vertical direction; and
a horizontal leg component coupled to the vertical leg component, the horizontal leg component configured to actuate the foot component between a stowed position substantially within the interior volume and an extended position substantially outside the interior volume.

2. The catwalk of claim 1, wherein the vertical leg component comprises:
a vertical fixed leg member; and
a vertical movable leg member slidably coupled to the vertical fixed leg member.

3. The catwalk of claim 2, wherein the vertical leg component further includes:
a first actuator, configured to move the vertical movable leg member relative to the vertical fixed leg member.

4. The catwalk of claim 1, wherein the horizontal leg component comprises:
a horizontal fixed leg member; and
a horizontal movable leg member slidably coupled to the horizontal fixed leg member.

5. The catwalk of claim 4, wherein the vertical leg component further includes:
a second actuator, configured to move the horizontal movable leg member relative to the horizontal fixed leg member.

6. The catwalk of claim 1, wherein the foot component comprises:
a foot housing; and
a foot slidably coupled to the foot housing, wherein the foot is configured to move the vertical leg component along the foot housing.

7. The catwalk of claim 1, wherein the leg assembly further includes:
a coupler, configured to couple the vertical leg component to the foot component.

8. The catwalk of claim 7, wherein the coupler is a lock and wheel component, and wherein the wheel is configured to turn the foot component in a desired direction and the lock is configured to lock the wheel in place.

9. The catwalk of claim 1, wherein the leg assemblies are configured to move the catwalk when the leg assemblies are in the extended position.

10. A method for moving a catwalk having a plurality of leg assemblies, comprising:
extending a horizontal leg component such that a foot component is moved from a stowed position within an interior volume of the catwalk to an extended position outside the interior volume; and
extending a vertical leg component such that the foot component contacts a ground and raises the catwalk from the ground.

11. The method of claim 10, further comprising moving the catwalk laterally or forward using the leg assemblies.
